(19) United States
(12) Patent Application Publication
(10) Pub. No.: US 2005/0228520 A1
(43) Pub. Date: Oct. 13, 2005

(54) Compressed digital music adapting apparatus for vehicles

(76) Inventor: Hung-Hsiang Yeh, Taipei (TW)

Correspondence Address: RABIN & BERDO, P.C., 1101 14 Street, N.W., Suite 500, Washington, DC, 20005, US

(21) Appl. No.: 10/826,402

(22) Filed: Apr. 19, 2004

(30) Foreign Application Priority Data
Apr. 1, 2004 (TW) 93204997

(51) Int. Cl. G06F 17/00

(52) U.S. Cl. 700/94

(57) ABSTRACT

A compressed digital music adapting apparatus for vehicles is described, which includes an adaptor having both a USB port and a cigarette-lighter charger port, a power regulator, and an FM modulator/transmitter. The power regulator regulates the voltage of the USB port and the cigarette-lighter charger port, and the FM modulator/transmitter modulates compressed digital music from a digital music player and then transmits the modulated music to an FM receiver of a vehicle when the adapting apparatus is docked such that the compressed digital music is broadcasted inside the vehicle. Moreover, the digital music player, as well as a power switch and an audio switch, may be integrated into the adaptor. As a result, the adapting apparatus possesses the broader functionality of broadcasting the compressed digital music through the USB port to a computer or through the cigarette-lighter charger port to a vehicle.

### FIELD OF THE INVENTION

The present invention relates to an adaptor, and more particularly, to a compressed digital music adapting apparatus for vehicles.

### BACKGROUND OF THE INVENTION

Due to the rapid development of the Internet and the multimedia industry and also to the insatiable human desire to be entertained, various kinds of music storage devices and broadcast systems have continued to emerge over the years. Technology has evolved from phonographic discs and phonographs, and magnetically recorded tapes and magnetic recorders in the early days, to compact discs (CDs) and digital versatile discs (DVDs), and more recently to flash memories for storing MPEG layer 3 (MP3) audio data and MP3 players. Popularity for magnetically recorded tapes has especially waned over the years because magnetic media are demagnetized easily by ultraviolet rays, thereby shortening their lifetimes, and furthermore have relatively small recording capacities.

MP3 audio data are compressed and stored in semiconductor memories, such as read-only memories (ROMs), erasable programmable read-only memories (EPROMs), and flash memories. Hence, an MP3 audio file usually occupies around 3 to 5 megabytes of memory, which is considerably smaller than that of a CD audio file. The music fidelity of the decoded MP3 audio data is good enough for most users. Consequently, many users convert CD audio data to MP3 audio data and store the data in computers that have MP3 players or in portable MP3 players. The MP3 players decode MP3 audio data and broadcast music.

MP3 players and other digital music players possess many advantages, like being small and lightweight. However, such a characteristic of portability entails that the speakers equipped with the digital music players are also small, making compressed digital music, such as MP3 music, unlikely to be broadcasted publicly. This is especially evident in a vehicular compartment, where the driver and the passengers cannot appreciate compressed digital music together unless the vehicle is outfitted with special equipment.

### SUMMARY OF THE INVENTION

It is the objective of the present invention to provide an adapting apparatus for broadcasting compressed digital music by means of the original vehicular equipment.

According to the aforementioned objective of the present invention, a compressed digital music adapting apparatus for a vehicle is provided. The adapting apparatus modulates compressed digital music by frequency modulation (FM) and transmits the music to an FM receiver of the vehicle. The compressed digital music is then broadcasted through the vehicular amplifiers to the public.

In accordance with a preferred embodiment of the present invention, an adapting apparatus has a USB port, a cigarette-lighter charger port, an audio-in jack, a power regulator, and an FM modulator/transmitter. The power regulator is used to regulate the voltages of the ports. The FM modulator/transmitter modulates MP3 music received by the audio-in jack and transmits the modulated MP3 music to an FM receiver of a vehicle. The MP3 music is then broadcasted via original amplifiers of the vehicle.

In accordance with another preferred embodiment of the present invention, an adapting apparatus has a USB port, a cigarette-lighter charger port, a power regulator, an FM modulator/transmitter, an MP3 player, a power switch for selectively activating ports, and an audio switch for selecting output media. MP3 music is broadcasted selectively through the USB port or through the cigarette-lighter charger port when the adapting apparatus is docked. For example, if a user selects the USB port to broadcast the MP3 music, the power switch and the audio switch respectively shift to the USB port and a proper output medium, e.g. a headphone. If a user selects the cigarette-lighter charger port to broadcast the MP3 music, the power switch and the audio switch respectively shift to the cigarette-lighter charger port and a proper output medium, a vehicular speaker for instance.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 illustrates an exterior of an MP3 adapting apparatus for vehicles in accordance with a preferred embodiment of the present invention;

FIG. 2 illustrates a block diagram of an interior circuit in accordance with the MP3 adapting apparatus of FIG. 1;

FIG. 3A and FIG. 3B illustrate different exteriors of an MP3 adapting apparatus for vehicles in accordance with another preferred embodiment of the present invention; and

FIG. 4 illustrates a block diagram of an interior circuit in accordance with the MP3 adapting apparatuses of FIG. 3A and FIG. 3B.

### DETAILED DESCRIPTION OF THE PREFERRED EMBODIMENTS

For broadcasting compressed digital music in a vehicular compartment by means of original vehicular equipment, adapting apparatuses for vehicles in accordance with the preferred embodiments of the present invention are disclosed in detail as follows, taken in conjunction with the accompanying drawings. The MP3 music and MP3 players mentioned below are only examples to illustrate the embodiments conveniently and are not proposed to limit the present invention. The adapting apparatuses according to the invention can adapt to or integrate with other types of digital music players as well as modulate other formats of compressed digital music, such as that of code excited linear prediction (CELP), window media audio (WMA), and advanced audio coding (AAC), without departing from the scope and the spirit of the invention.

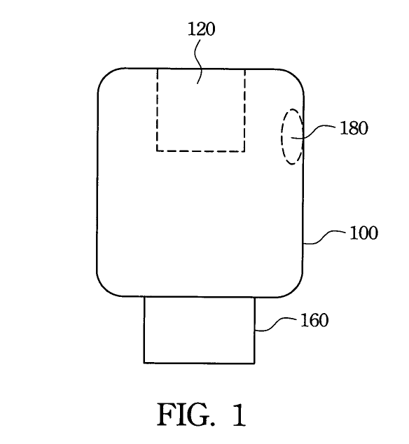

FIG. 1 illustrates an exterior of an MP3 adapting apparatus for a vehicle in accordance with a preferred embodiment of the present invention. The main body of an adaptor 100 has a universal serial bus (USB) port 120, an audio-in jack 180, and a cigarette-lighter charger port 160 as shown in FIG. 1. The USB port 120 receives a general USB port of an MP3 player, and the audio-in jack 180 receives an audio-out plug of the MP3 player. Additionally, the cigarette-lighter charger port 160 receives power from the vehicle. Therefore, the MP3 player is integrated with a conventional vehicle by docking the adaptor 100 into the cigarette-lighter charger port of the vehicle.

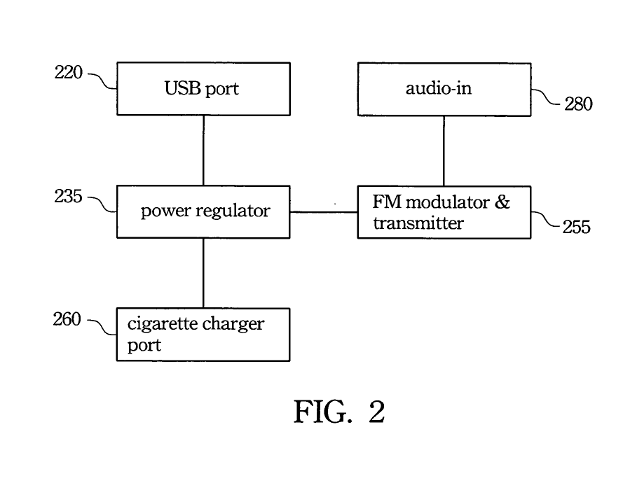

Referring to FIG. 2, which illustrates a block diagram of an interior circuit in accordance with the MP3 adapting apparatus of FIG. 1, a power regulator 235 and an FM modulator/transmitter 255 are contained inside the main body of the adaptor, also are a USB port 220, a cigarette-lighter charger port 260, and an audio-in jack 280. The power regulator 235 is electrically coupled to both the USB port 220 and the cigarette-lighter charger port 260 in order to regulate the voltages thereof and thus supply adequate power to the FM modulator/transmitter 255. In general, the voltage of the cigarette-lighter charger port 260 is around 12 volts, and the voltage of the USB port 220 is about 5 volts or about 3 volts. The FM modulator/transmitter 255 modulates MP3 music received from an MP3 player connected to the audio-in jack 280 and transmits the modulated MP3 music to an FM receiver of the vehicle. Consequently, the MP3 music is broadcasted in the vehicular compartment through original equipment of the vehicle, for example, amplifiers and speakers.

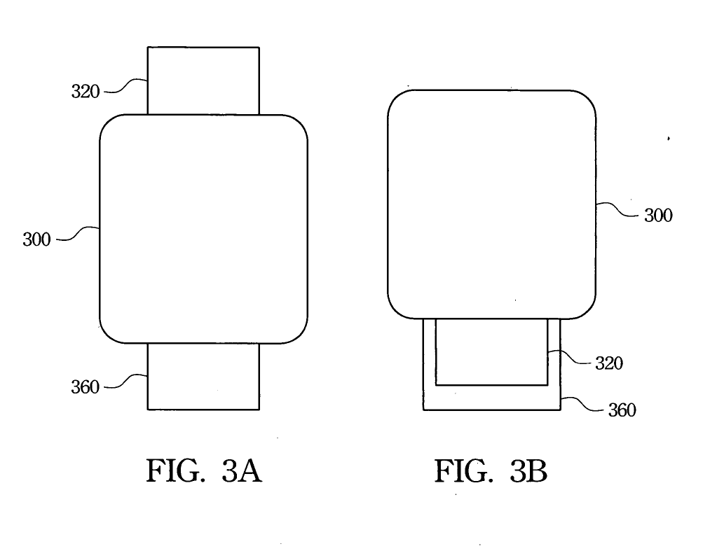

Furthermore, an MP3 player can be integrated with the main body of the adaptor mentioned above. As a result, the adapting apparatus not only has the ability to broadcast MP3 music via vehicular equipment, but also has the ability to broadcast MP3 music via the inherent USB interface of the MP3 player. FIG. 3A illustrates an exterior of an MP3 adapting apparatus for vehicles in accordance with another preferred embodiment of the present invention. Referring to FIG. 3A, the MP3 adapting apparatus has the main body of an adaptor 300, a USB port 320, and a cigarette-lighter charger port 360 opposite the USB port 320. Moreover, the MP3 adapting apparatus may have the main body of an adaptor 300, a USB port 320, and a cigarette-lighter charger port 360 plugged over the USB port 320, as illustrated in FIG. 3B, such that the cigarette-lighter charger port 360 is attached only when needed. In this preferred embodiment, an MP3 player is integrated inside the main body of the adaptor 300 for preparing MP3 music. The main body also contains an FM modulator/transmitter for modulating and transmitting MP3 music and a power regulator for regulating voltages of the different ports therein. For example, about 12 volts is applied to the cigarette-lighter charger port 360, but the USB port 320 usually requires about 5 volts or about 3 volts.

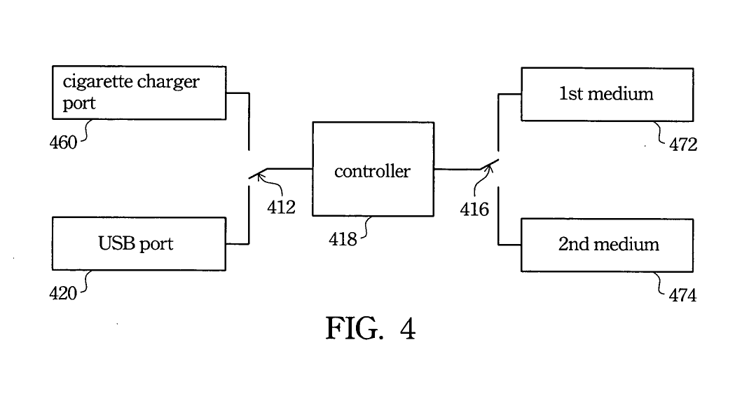

Referring to FIG. 4, which shows a block diagram of an interior circuit in accordance with the MP3 adapting apparatuses of FIG. 3A and FIG. 3B, a controller 418, a power switch 412, and an audio switch 416 are disposed in the interior circuit. An MP3 player, a power regulator, an FM modulator/transmitter, and a control interface are integrated inside the controller 418, a design of which permits various ways for users to broadcast MP3 music. When users choose the USB port to broadcast the MP3 music via the control interface, the power switch 412 shifts to the USB port 420. The power regulator regulates the voltage according to the USB port 420 and supplies adequate power to the MP3 player. Concurrently, the audio switch 416 shifts to a first medium 472 for broadcasting the MP3 music. The first medium 472 comprises a speaker or a headphone. Conversely, when users choose the cigarette-lighter charger port to broadcast the MP3 music via the control interface, the power switch 412 and the audio switch 416 respectively shift to the cigarette-lighter charger port 460 and a second medium 474, which comprises at least a vehicular speaker. Furthermore, the power regulator inside the controller 418 regulates the voltage according to the cigarette-lighter charger port 460 and supplies adequate power to the MP3 player and the FM modulator/transmitter. The FM modulator/transmitter then modulates the MP3 music from the MP3 player and transmits the modulated MP3 music to an FM receiver of the vehicle. As a result, the MP3 music is broadcasted through the second medium 474. Therefore, the adapting apparatus in accordance with this preferred embodiment provides two ways to broadcast MP3 music, that is, by the USB port, through which the MP3 music can be broadcasted on computers; and by the cigarette-lighter charger port, through which the MP3 music can be broadcasted in a vehicular compartment. Users are thus given the freedom to choose which method is best depending on equipment and occasion.

According to the aforementioned preferred embodiments of the present invention, the adapting apparatus redeems the shortage of MP3 equipment on vehicles. MP3 music can be broadcasted by means of original vehicular equipment while the adapting apparatus is docked. Furthermore, the MP3 adapting apparatus combining an adaptor with an MP3 player possesses both the functionality of broadcasting MP3 music by a USB port, such as that on a computer, as well as by a cigarette-lighter charger port, such as that in a vehicle.

While the invention has been particularly shown and described with reference to the preferred embodiments instancing MP3 music and an MP3 player as compressed digital music and a digital music player, these are merely examples to help clarify the invention and are not intended to limit the invention. It will be understood by those skilled in the art that various changes, modifications, and alterations in form and details may be made therein without departing from the spirit and scope of the invention, as set forth in the following claims.

1. A compressed digital music adapting apparatus for vehicles, the apparatus comprising:
a main body of an adaptor having a USB port and a cigarette-lighter charger port;
a power regulator inside the main body of the adaptor for regulating a voltage; and
an FM modulator/transmitter for modulating and transmitting compressed digital music, wherein the FM modulator/transmitter is inside the main body of the adaptor and is electrically coupled to the power regulator.

2. The apparatus of claim 1, further comprising:
a digital music player;
a power switch for switching between the USB port and the cigarette-lighter charger port; and
an audio switch for selecting between and transmitting the compressed digital music to a first medium and a second medium.

3. The apparatus of claim 2, wherein the first medium comprises at least a speaker or a headphone.

4. The apparatus of claim 2, wherein the second medium comprises at least a vehicular speaker.

5. The apparatus of claim 1, wherein the main body of the adaptor further comprises an audio-in jack, wherein the audio-in jack is used to connect to an audio-out plug of a digital music player.

6. The apparatus of claim 1, wherein the voltage is about 12 volts for the cigarette-lighter charger port.

7. The apparatus of claim 1, wherein the voltage is about 5 volts or about 3 volts for the USB port.

8. The apparatus of claim 1, wherein the compressed digital music comprises an MP3 format, a CELP format, a WMA format, or an ACC format.

9. An adapting apparatus, which docks a digital music player to a vehicle, the apparatus comprising:
a main body of an adaptor having a USB port, a cigarette-lighter charger port, and an audio-in jack;
a power regulator inside the main body of the adaptor for regulating a voltage; and
an FM modulator/transmitter for modulating and transmitting compressed digital music from the digital music player to the vehicle, wherein the FM modulator/transmitter is inside the main body of the adaptor and is electrically coupled to the power regulator.

10. The apparatus of claim 9, wherein the vehicle further comprises an FM receiver for receiving the compressed digital music, and at least an amplifier for broadcasting the compressed digital music.

11. The apparatus of claim 9, wherein the voltage is about 12 volts for the cigarette-lighter charger port.

12. The apparatus of claim 9, wherein the voltage is about 3 volts or about 5 volts for the USB port.

13. The apparatus of claim 9, wherein the compressed digital music comprises an MP3 format, a CELP format, a WMA format, or an ACC format.

14. An adapting apparatus for compressed digital music, which can be used in a vehicle, the apparatus comprising:
a main body of an adaptor having a USB port and a cigarette-lighter charger port;
a digital music player inside the main body of the adaptor for transmitting compressed digital music;
an FM modulator/transmitter inside the main body of the adaptor for modulating and transmitting the compressed digital music;
a power regulator for regulating a voltage, wherein the power regulator is inside the main body of the adaptor and is electrically coupled to the FM modulator/transmitter;
a power switch for switching between the USB port and the cigarette-lighter charger port; and
an audio switch for selecting between and transmitting the compressed digital music to a first medium and a second medium.

15. The apparatus of claim 14, wherein the vehicle further comprises an FM receiver for receiving the compressed digital music.

16. The apparatus of claim 14, wherein the first medium comprises at least a speaker or a headphone.

17. The apparatus of claim 14, wherein the second medium comprises at least a vehicular speaker.

18. The apparatus of claim 14, wherein the voltage is about 12 volts for the cigarette-lighter charger port.

19. The apparatus of claim 14, wherein the voltage is about 5 volts or about 3 volts for the USB port.

20. The apparatus of claim 14, wherein the compressed digital music comprises an MP3 format, a CELP format, a WMA format, or an ACC format.
